(19) United States
(12) Patent Application Publication
(10) Pub. No.: US 2012/0214879 A1
(43) Pub. Date: Aug. 23, 2012

(54) CHEMICAL SYSTEM WITH SELF-TIMING INDICATOR

(75) Inventor: Douglas C. Arndt, Glendora, CA (US)

(73) Assignee: Infection Prevention Systems, Inc., Glendora, CA (US)

(21) Appl. No.: 13/462,721

(22) Filed: May 2, 2012

Related U.S. Application Data
(63) Continuation-in-part of application No. 12/283,541, filed on Sep. 12, 2008, now abandoned.
(60) Provisional application No. 60/960,021, filed on Sep. 12, 2007.

(51) Int. Cl. A01N 31/02; A01P 1/00; A01N 25/00

(52) U.S. Cl. 514/724; 514/785

(57) ABSTRACT

A pH-modified luminescent composition and methods. In composition, a marker exhibiting luminescence change over a indicatory period. pH-based luminesce change may be in intensity or in wavelength. One embodiment provides a luminescent composition, including a selected luminescent marker having a first phase; and a selected ionizing agent comprising a second phase. The selected luminescent marker exhibits luminescence for an indicatory period responsive to intermixing of the first phase with the second phase. A selected antimicrobial agent combined with the first phase of the luminescent composition, wherein intermixing of the first phase with the second phase is at least a portion of a hand hygiene protocol. A method embodiment of using the luminescent composition, can include providing a luminescent marker; providing a ionizing agent; intermixing the luminescent marker with the ionizing agent; causing a change in pH in the selected luminescent marker; and exhibiting luminescence for a predetermined indicatory period.

### CROSS-REFERENCE TO RELATED PATENTS AND PATENT APPLICATIONS

This application claims the benefit of prior-filed provisional patent application U.S. Ser. No. 60/960,021, filed Sep. 12, 2007, which is incorporated by reference herein in its entirety. This application also is related to co-pending PCT International Application No. PCT/US2007/022954, filed Oct. 31, 2007 and entitled “HAND HYGIENE VERIFICATION/TRACKING SYSTEM AND METHOD,” and related to co-pending PCT International Application No. PCT/US2007/022843, filed Oct. 30, 2007 and entitled “VERIFIABLE HAND CLEANSING METHOD AND FORMULATION,” as well as a continuation-in-part to co-pending “CHEMICAL SYSTEMS WITH SELF-TIMING INDICATOR” U.S. Ser. No. 12/283,541, filed Sep. 20, 2008, all of which are assigned to the same assignee hereof, and all of which are incorporated by reference herein in their respective entirety.

### FIELD OF THE INVENTION

The invention is generally related to luminescent compositions and related methods, in particular, to luminescent compositions used to enforce compliance with hand hygiene protocols.

### BACKGROUND

Hospital-acquired (nosocomial) infections are a major cause of illness and death, and impose serious economic costs on patients and hospitals. Indeed, health care-associated infections rank in the top five causes of death, with an estimated 90,000 deaths each year in the United States. Cross transmission is estimated to cause 40% of nosocomial infections. Pathogens are readily transmitted on the hands of a healthcare worker (HCW), and effective hand hygiene substantially reduces this transmission. For well over 150 years, handwashing has been universally accepted as one of the most important measures for preventing transmission of pathogens in health-care facilities and other community settings. However, compliance with established handwashing guidelines remains poor, averaging about 40%, internationally. The reasons for non-compliance are complex, occurring at individual, group and institutional levels.

An important factor in the efficacy of a handwashing regimen is washing time, or the amount of time a HCW actively washes their hands. In recent studies, HCWs have been observed to wash their hands for less than 24 seconds, and frequently, for less than 10 seconds, with an average of approximately 12.6 seconds. In an effort to reduce the time needed to provide sufficient hand hygiene and to increase compliance with hand hygiene guidelines, waterless hand rubs having antimicrobial agents have been developed. Even so, to be efficacious, waterless hand rubs benefit from a recommended contact time, or the amount of time during which a health care worker brings an active antimicrobial agent in contact with the skin of their hands. Frequently, due to the pressures of patient care, a HCW may be unaware of elapsed washing or contact time, which may be insufficient. Furthermore, a hurried worker may use poor hand hygiene techniques, such as inadequate rubbing, which may increase the likelihood of cross-contaminating a patient. In some circumstances, for example, when a strict hand hygiene protocol is in effect, a health care facility may employ a covert observer to enforce compliance. However, current techniques used to monitor hand hygiene compliance typically use inferential or proxy methods, instead of direct measurement. Therefore, there is a need for apparatus, compositions, and methods of indicating acceptable hand hygiene washing or contact time.

### SUMMARY OF THE INVENTION

Embodiments herein provide a pH-modified luminescent apparatus and methods. In an apparatus, a marker that exhibits luminescence change over a predetermined indicatory period. pH-based luminesce change may be in luminescent intensity or in luminescent wavelength (chromic shift). One embodiment provides a luminescent composition, including a selected luminescent marker comprising a first phase of the luminescent composition; and a selected ionizing agent comprising a second phase of the luminescent composition. The selected luminescent marker exhibits luminescence for a predetermined indicatory period responsive to intermixing of the first phase of the luminescent composition with the second phase of the luminescent composition. Due to a change in pH for a predetermined indicatory period, a luminance intensity remains at least at a threshold intensity. The embodiments also can exhibit luminescence for a predetermined indicatory period responsive to an excitatory light applied to the luminescent composition. Responsive to an excitatory light applied to the luminescent composition, a selected luminescent marker is formed from an intermixture of the first phase of the luminescent composition with the second phase of the luminescent composition exhibits luminescence. Certain embodiments can include a selected antimicrobial agent combined with the first phase of the luminescent composition, wherein intermixing of the first phase of the luminescent composition with the second phase of the luminescent composition is at least a portion of a hand hygiene protocol. Alternatively, the luminescent compound can include a selected antimicrobial agent combined with the first phase of the luminescent composition, wherein an intermixture of the first phase of the luminescent composition with the second phase of the luminescent composition is applied to at least a portion of a human hand, and wherein application of the luminescent composition comprises at least a portion of a hand hygiene protocol. In embodiments of the composition, the wherein the selected luminescent marker includes a coumarinic compound and the selected ionizing agent includes a base having an ammonium compound therein. Alternately, an embodiment has the selected luminescent marker including a coumarinic compound, where the selected ionizing agent includes a base having an ammonium compound therein. In this case, the excitatory light has a wavelength of between about 200 nm to about 400 nm. In an alternative embodiment, the excitatory light has a wavelength of between about 400 nm to about 700 nm. In yet another alternative embodiment, the excitatory light has a wavelength of between about 700 nm to about 1 mm. In another embodiment the selected luminescent marker includes a coumarinic compound, the selected ionizing agent includes a base having an ammonium compound therein, the excitatory light has a wavelength of between about 200 nm to about 400 nm and the selected antimicrobial agent is ethanol, propanol, n-propanol, or an antimicrobially efficacious combination thereof, and wherein the selected antimicrobial agent has an alcohol concentration by weight of between about 60% and about 90%. Embodiments of the invention also provide a luminescent composition, having a selected luminescent marker comprising a first phase of the luminescent composition; and a selected ionizing agent comprising a second phase of the luminescent composition. In this case, the selected luminescent marker exhibits luminescence for a predetermined indicatory period responsive to intermixing of the first phase of the luminescent composition with the second phase of the luminescent composition, and wherein, due to a change in pH for a predetermined indicatory period, a chromic shift remains at least at a threshold intensity.
A method embodiment of using the luminescent composition, can include providing a selected luminescent marker; providing a selected ionizing agent; intermixing the selected luminescent marker with the selected ionizing agent; causing a change in pH in the selected luminescent marker, responsive to the intermixing; and exhibiting luminescence for a predetermined indicatory period, responsive to the intermixing. The method can include luminescence is produced by an excitatory light having a wavelength of between about 200 nm to about 400 nm, or from about 400 nm to about 700 nm, or from about 700 nm to about 1 mm. In an alternative embodiment of the method, exhibiting luminescence further includes exhibiting a change in luminescence intensity for a predetermined indicatory period. In embodiments of the invention, exhibiting luminescence further comprises exhibiting a change in luminescence wavelength for a predetermined indicatory period or exhibiting a change in the luminescence wavelength for the predetermined indicatory period.

### BRIEF DESCRIPTION OF THE DRAWINGS

The present invention is illustrated by way of example and not by limitation in the accompanying figures, in which like references indicate similar elements, and in which:

FIG. 1 is a graphical illustration of luminance intensity, as a function of time, for a single phase luminescent composition; and

FIG. 2 is a graphical illustration of luminance intensity, as a function of time, for a plural phase luminescent composition, in accordance with the teachings of the present invention.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF THE EMBODIMENTS

The embodiments herein provide apparatus for, compositions for, and methods of, enforcing compliance with acceptable hand hygiene washing or contact time, hand hygiene technique, or both, using a chemical system incorporating a self-timed indicator, for example, a self-timed luminescent indicator. The embodiments herein include pH-dependent intensity and chromic shifts, and not shifts due to the polarity shift of a solvent composition. The emission maximum is shifted by means of pH control using acids and bases as opposed to emission color or intensity shifting by the use pof polar and non-polar solvents. As used herein, the term “luminescence” may pertain to fluorescence, phosphorescence, and chemiluminescence, as well as to selective absorbance of predefined wavelength regions of the electromagnetic spectrum, such as infrared (IR) and near infrared (NIR). Also, as used herein, the term “phase” pertains to a physical location and not to a phase of matter, a time, or a stage in a process. For example, in a “two-phase” system, reactive ingredients are maintained in separate parts until they are mixed in the hands. Likewise, in a single-phase system, components are mixed prior to packaging into a single vessel.

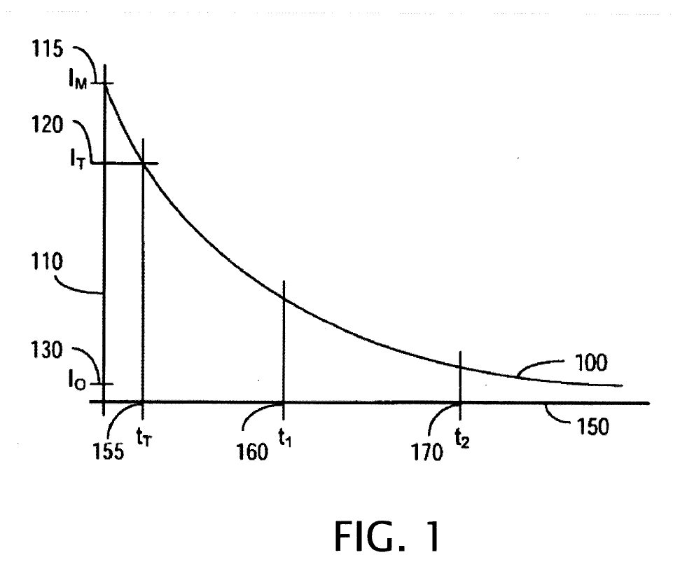

A luminescent composition is one which emits (or absorbs) light, which is not derived from the temperature of the emitting body. In addition, the term “indicatory period” pertains to a predetermined interval of luminescence produced by a self-timed luminescent indicator. A luminescent indicator may be an evanescent luminescent indicator or a persistent luminescent indicator. An evanescent luminescent indicator may luminesce for an indicatory period on the order of about seconds to minutes, for example between about 30 seconds to about 120 seconds. A persistent luminescent indicator may luminesce for an indicatory period on the order of minutes to hours, for example, about 3 hours to about 5 hours. There may not be a sharp, objective defining point between evanescent and persistent indicatory periods, but the term may bear a functional correspondence to an application of a luminescent composition. In any event, in accordance with the teachings herein, an indicatory period corresponding to a luminescent composition may be modified to provide longer or shorter intervals of luminescence, for example, by modifying one or more constituents thereof. Note that pH-dependent fluorescence is not related to the use of an ionizing base with a carbomer to form a gel. Turning to FIG. 1, luminance intensity (I) 110 characteristic of a typical mono-component luminescent material may be depicted as a function 100 of time (t) 150 elapsed after luminescent composition activation. Maximum intensity (I_{M}) 115 may be attained upon activation at t=0 seconds. However, shortly thereafter, at the interval from t=0 to t=t_{T} 155, luminescence of the material may decay rapidly towards baseline intensity (I_{O}) 130, reaching threshold intensity I_{T} 120 by t=t_{T} 155. Intermediate time marker t₁ 160 may represent a first handwashing interval from t=0, conducive to efficacious hand cleaning, for example, about 30 seconds. Later time marker t₂ 170 may represent a second handwashing interval conducive to efficacious hand cleaning, for example, about 60 seconds. For illustration purposes, the interval from t=0 to t=t_{T} is depicted to be about 5 seconds, which may be inadequate time for efficacious hand hygiene. In implementations in which photometric measurements may be used as a proxy for actual completion of efficacious hand hygiene, in particular, measurement of threshold luminance intensity I_{T} 120, the measured value may produce an incorrect inference of effective hand hygiene.

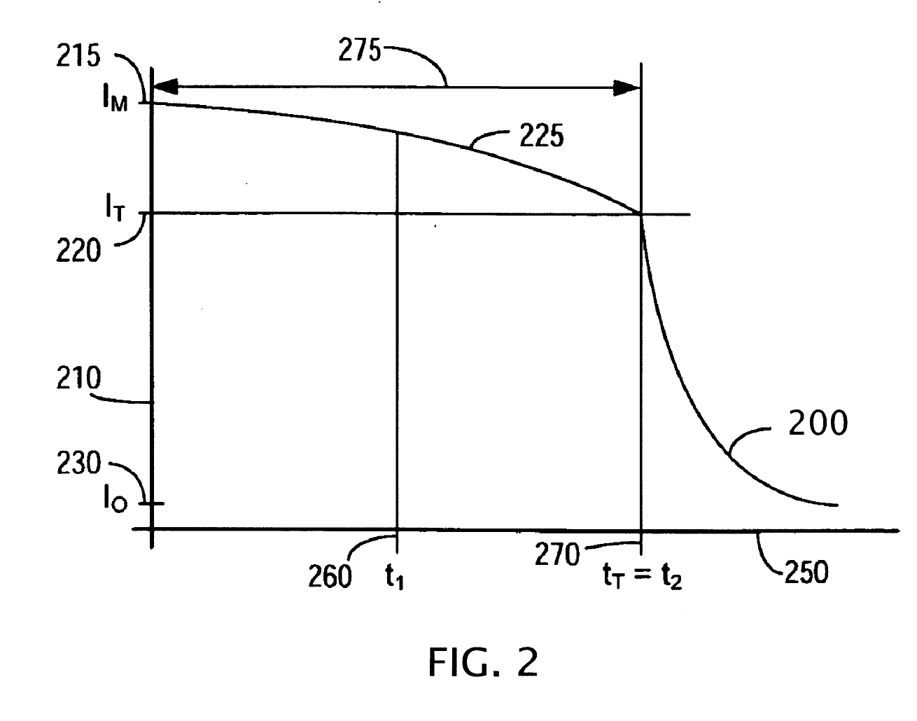

Turning to FIG. 2, a luminance intensity (I) 210 characteristic of a multi-component luminescent composition in accordance with the present embodiments also may be depicted as a function 200 of time (t) 250 elapsed after luminescent composition activation. However, present luminescent composition embodiments may be constituted to provide a predetermined indicatory period 275, during which such a present luminescent composition embodiment may display enhanced luminance intensity 225 (e.g., I_{M}≦I≦I_{T}) over predetermined indicatory period 275, may decay to approximately threshold intensity, I_{T}, 220 by the expiry of predetermined indicatory period 275. Thereafter, luminance intensity I, and may exhibit a rapid decay of intensity to approximately baseline intensity I_{O} 230. Similar to FIG. 1, intermediate time marker t₁ 260 may represent a first handwashing interval from t=0, conducive to efficacious hand cleaning, for example, about 30 seconds, and later time marker t₂ 270 may represent a second handwashing interval conducive to efficacious hand cleaning, for example, about 60 seconds. For illustration purposes, a present luminescent composition embodiment is depicted to provide a predetermined indicatory period 275 from about t=0 to about t=t₂, for example, about 60 seconds. Thus, a present luminescent composition embodiment may be conducive to efficacious hand hygiene measures. In addition, present embodiments may be disposed to measure actual hand hygiene, instead of a proxy therefor.

In selected embodiments herein, a limited amount of time may be permissible between an efficacious hand washing event and subsequent patient contact. In such embodiments, an evanescent luminescent indicator may be used, for example, about 45 seconds. Embodiments of the present invention provide a luminescent composition having an evanescent luminescent indicator, which may provide an indicatory period of between about 30 seconds to about 60 seconds. In such embodiments, luminance intensity drops off sharply after the indicatory period, indicating that an undesirable lapse of time between an efficacious hand hygiene event, and luminance intensity measurement. For example, under a hand hygiene protocol, a HCW may need to engage in a patient-related activity within about 45 seconds of an efficacious hand hygiene event. If the HCW is photometrically determined to exhibit sufficient luminescence, then the HCW may approach the patient; otherwise the HCW may need to repeat a hand hygiene procedure in accordance with the prevailing protocol. Thus, not only does the presence of evanescent luminescent indicator confirm that an efficacious hand hygiene event has been performed by the HCW, the indicator presence also confirms that the HCW performed the efficacious hand hygiene event within the indicatory period. Luminescent compositions in accordance with present embodiments generally include a selected luminescent marker, a selected antimicrobial agent, and a selected ionizing agent. A selected ionizing agent may cause an embodiment of a luminescent composition to exhibit luminescence over a predetermined indicatory period. Typically, the form of the luminescent may be a solution or a gel, although other non-limiting examples of luminescent composition forms may include a cream, a lotion, a solution, a liquid, a soap, a shampoo, a jelly, an aerosol, a foam, or one or more constituent elements thereof.

A selected luminescent marker may include, but is not limited to, coumarinic compounds, such as coumarin, 7-hydroxy coumarin (umbelliferone), 7-hydroxy-4-methylcoumarin (4-methylumbelliferone, or 4-MU), or 6-glucoside umbelliferone (esculin), 7-hydroxy-4-(trifluoromethyl) coumarin, and aromatic compounds having at least one fused ring (benzene derivatives). An aromatic compound with two or more fused rings (e.g. naphthalenes, anthracenes) may be used to provide a selected luminescent marker, which is strongly fluorescent when ionized in a solvent, acid, or base, for example, a selected ionizing agent. A suitable selected luminescent marker also may be a solvent-dependent or pH-dependent (environmentally sensitive) fluorophors, such as pyrene-1-sulfonyl chloride, pyrene-8-hydroxy-1,4,6-trisulfonyl chloride, quinine and its salts, quinoids including quinolines and quinines. Carbazol may be used as a selected luminescent marker, which provides a persistent luminescent indicator, in the presence of sodium hydroxide. Unlike other markers, which may rely on a solvent dependent chromic shift in emission color, the embodiments herein employ an increase in fluorescence intensity (quantum yield), in which the intensity change is dependent upon pH change, or to induce a pH-dependent chromic shift that is not dependent on the polarity of a solvent or the lack thereof. Also, some fluorophors may fluoresce brightly without pH control, and such fluorophors are not suitable for the present embodiments that rely on pH-dependent fluorescence intensity (quantum yield).

A suitable selected ionizing agent may be a solvent, acid, or base. In base form, a selected ionizing agent may comprise at least one alkalizing agent, which alkalizing agent may serve as a source of ammonium ions, ammonia, or both. An alkanolamide may be used as an alkalizing agent, as may any other alkalizing agent known in the art. Non-limiting examples of an alkanolamide include monoethanolamine (MEA), diethanolamine (DEA), triethanolamine (TEA), monopropanolamine (MPA), dipropanolamine (DPA), tripropanolamine (TPA), 2-amino-2-methyl-1,3-propanediol (AMPD), 2-amino-2-methyl-1-propanol (AMP), and 2 amino-2-hydroxymethyl-1,3-propanediol (THAM) and guanidium salts. Alkanolamines, alkylamines, alkali hydroxides, and alkali carbonates also may be used as other volatile bases such as, without limitation, pyridine, piperazine, amino methylpyridines, amino ethyl pyridines, amino methoxy pyridines, amino ethyl pyrrolidines, and amino methyl piperazines.

Other non-limiting examples of ammonium sources include ammonium carbonate, ammonium carbamate, ammonium hydrogen carbonate, ammonia, and mixtures thereof, although ammonium chloride, ammonium sulphate, ammonium nitrate, ammonium phosphate, ammonium acetate, ammonium hydroxide, and mixtures thereof, also may be used as ammonium sources. The present embodiments use pH control for the purpose of creating a carbomer gel. They do not induce fluorescence by way of ionization of a fluorophor. The embodiments herein produce a composition that can measure the elapsed time after an event, using pH-dependent fluorescence. In selected embodiments, a composition including a selected luminescent marker may not exhibit luminescence until at least partly mixed with a selected ionizing agent, providing a two-phase luminescent composition. Constituents described herein may be obtained, for example, from Sigma-Aldrich Corp., St. Louis, Mo., USA, or from Spectra Colors Corp., Kearny, N.J., USA. A luminescent marker and an ionizing agent may be selected to exhibit preselected luminescent characteristics.

In yet another embodiment of the present invention, amine-reactive fluorophors may be used, which exhibit a very low level of fluorescence until conjugated with an amine. Once conjugated, these fluorophors can become very brightly fluorescent. These fluorophors may conjugate with amino acids in peptides and proteins present on the surface of the skin, so that they can be employed two ways: (1) by reacting with amine-containing bases, as previously described; or (2) by reacting them with the skin of the hands, using pH to initiate a rapid conjugation that also is temporary enough to be so controlled as to measure time on the skin.

Amine reactive reagents suitable for our invention include fluorescamine, o-phthalaldehyde, 4-dimethylaminocinnamaldehyde, dansyl chloride, 8-anilino-1-napthalenesulfonic acid (and its salts), 4-chloro-7-nitrobenzofurazan, fluorescein isothiocyanate, zinc-complexed ninhydrin, 1,2-indanedione, 5-methylthioninhydrin, and 1,8-diazafluoren-9-one. Of these, fluorescamine and dansyl chloride fluoresce strongly in UV light after conjugation with an amine, while the others fluoresce optimally in longer wavelengths ranging from blue (450 nanometers) to green (530 nanmeters). Although UV detectors using UV LEDS may be use to measure fluorescence, longer wavelength light sources, such as blue and green, are less costly than UV and are non-hazardous to the eyes. To humanly see or to electronically measure fluorescence in blue or green light a color filter that blocks the excitation light but transmits the emission light, may be used.

In certain embodiments, a suitable gel may include a diluent, such as water, in which is dispersed a gellant or a thickener, for example, a hydroxyethyl cellulose (HEC) material, a hydroxypropyl cellulose (HPC) material, an ethyl hydroxyethyl cellulose (EHEC) material, a hydroxypropyl methylcellulose (HPMC), or a polyamide ester material. Cellulosic materials may be hydrophobically modified materials, for example, to enhance carrier formulation viscosity. Hydrophobic formulations also may reduce tissue staining. In one non-limiting example, a suitable carrier formulation may be a gel including water as a diluent, and between about 0.5% to about 1.0% w/w of hydroxypropyl cellulose (HPC), having a viscosity of between about 4,000 centipoise to about 6,500 centipoise (as may be referenced by the apparent viscosity of a 2% HPC aqueous solution at 25° C.), which can be obtained from Spectrum Chemicals and Laboratory Products, Inc., Gardena, Calif. 90248 USA.

Other constituents also may be chosen to modify a predetermined indicatory period. For example, a selected corresponding binder also may be added to the selected luminescent marker, in embodiments in which the marker is intended to be in the form of a bead, or a microbead, form. A selected luminescent marker and a selected corresponding binder may be formed into a particulate cluster, an aggregate, an agglomerate, or a microbead, which can be held together mechanically, electrostatically (as in a suspension), or by using a binder (dry state). In this form, the detectability of the selected marker may be relatively low until disassociated from the corresponding binder, for example, by mechanical action associated with hand washing. Vigorous rubbing of the hands after applying an efficacious amount of an embodiment of the present chemical system in bead or microbead form can cause disassociation of the selected marker from the corresponding binder, and may facilitate intermixing of the selected marker with the selected ionizer such that a luminance intensity increases to about a maximum intensity, and remains above an intensity threshold for a predetermined indicatory period. Compositions and methods for forming and using such a bead or microbead, incorporating a selected luminescent marker, may be described further in co-pending PCT International Application No. PCT/US2007/022843, filed Oct. 30, 2007 and entitled “VERIFIABLE HAND CLEANSING METHOD AND FORMULATION,” which is incorporated by reference herein in its entirety. UV-induced fluorescence can be an example of microbeads embodiments herein in which microbeads cannot be inherently fluorescent. Instead, the microbeads are configured to become fluorescent when they are ionized by means of a pH change. Typically, the pH change must produce fluorescence for a predetermined time in which the fluorescence remains on the hands, instead of rinsing away the fluorescent lather during a quick water rinse. The microbeads may contain marker material which remains substantially non-fluorescent until the microbeads become ionized on the hands. In some embodiments, non-fluorescent, or feebly fluorescent, markers may be used that only respond to UV light when ionized by an acid. A superb example of such a marker is quinine and its salts, which become extremely fluorescent only with placed into acidic conditions. In fact, the standard for measuring fluorescence intensity (quantum yield) is that of quinine sulfate in low pH.

Alcohol-based hand rubs are certain embodiments, which may be better than traditional handwashing because they tend to require less time to use, act faster, may be less irritating, and may contribute to sustained improvement in compliance associated with decreased infection rates. According to some observers, using alcohol hand rub may increase compliance to hand hygiene guideline rates by about 25%. Alcohol may have a broad antimicrobial spectrum, in that it can be active against many bacteria and clinically important viruses, yeasts, and fungi. As a result, a suitable selected antimicrobial agent for a present luminescent composition embodiment may be an alcohol. Antimicrobial efficacy can be achieved with ethanol (about 60% to about 85%), isopropanol (about 60 to about 80%), or n-propanol (about 60% to about 80%). Ethanol at high concentrations (e.g., about 95%) may be an effective treatment against naked viruses, whereas n-propanol may be effective against the resident bacterial flora. The combination of alcohols may have a synergistic effect.

However, embodiments of the present invention also may be used in a water-based, liquid soap, containing no alcohol.

### Two Soap Solutions:

(1) A fluorescent agent composed of 2.5% by weight of fluorescent agent 8-anilino-1-naphthalene sulfonic acid in an aqueous solution of 10% glycol by weight is formulated, which in term is added to an over-the counter liquid soap from Dial™ (White Tea & Vitamin E Pearls) to constitute 0.1% by weight of the fluorescent agent. The modified soap solution is injected into a dispensing cartridge of a liquid soap dispenser available from Gojo Industries for usage in hand washing procedure. This type of soap solution is similar to the ones described in U.S. Pat. Nos. 5,250,223, 5,900,067 and 6,524,390.

(2) A separate set of formulations based on Spectra White PD dye (supplied from Spectra Color Corporation) is prepared. An amount of 10% by weight of the water soluble dye is combined with binder formed by lactose, microcrystalline cellulose and hydroxypropylmethylcellulose. The dye in the quantity of 1% by weight of the in aggregates is mixed into liquid foam soap supplied by Medline Industries, Inc. The much smaller particle size of a few microns allows the formulation to be dispensed through a fine filter as foam. The formulation changes Medline (supplied by Medline Industries, Inc., Mundelein, Ill.) soap's original orange-reddish color to more reddish color. See my co-pending PCT application referred to in the Relation Application Section for the other examples. This formulation is filled into a modified Gojo wall-mounted dispenser (described below) cartridge for dispensing. As is discussed in the above-mentioned co-pending PCT application, vigorous scrubbing is required to disassociate the marker from the binder to enable the marker to be detected.

### Two Rinse-Less Hand Cleansing Disinfectant Solutions:

(1) 7-hydroxymethyl coumarin (7-HMC or coumarin-4) dye supplied by Spectra Color Corp. as the fluorescent agent and 2-diethylamino-ethanol as a fluorescent maintenance agent are added into a non-alcohol disinfectant solution called “Hand Clens” supplied by Woodward Laboratory to constitute a solution with 0.1% by weight of the 7-HMC dye and 1% by weight of the 2-diethylamino-ethanol. This modified solution is dispensed as foam in a modified wall-mounted Gojo dispenser (described below).

(2) Coumarin-4 as a fluorescent agent and butyl amine as a fluorescent maintenance agent is added to a disinfectant of 70% ethanol to constitute an alcohol gel of 0.2% by weight of Coumarin-4 and 1% by weight of butyl amine. This alcohol gel is also dispensed from a modified wall-mounted Gojo dispenser for non-rinsing hand cleansing procedure. In general, a present luminescent composition embodiment can be constituted to luminescence for a predetermined indicatory period on the order of about seconds to minutes, for example, between about 30 seconds to about 60 seconds, and typically about 45 seconds, after a selected antimicrobial agent has been brought into efficacious contact with a target surface, such as the skin of a user's (HCW) hands. Increased luminescence may be triggered when the selected luminescent marker is at least partly mixed with a selected ionizing agent. Alternatively, increased luminescence may be triggered when the selected luminescent marker is at least partly mixed with a selected ionizing agent, and the mixture is energized by an excitatory light source. When photometrically quantified, luminance intensity can remain substantially near or above a predetermined intensity threshold, for example, during the process of hand cleaning. Typically, after a HCW has performed efficacious hand hygiene with selected ones of present embodiments, luminance intensity may remain above a threshold intensity over a threshold interval. Following the threshold interval, a luminance intensity of an activated luminescent composition may decay sharply below a corresponding threshold intensity to approach baseline intensity.

In others of present embodiments, after a HCW has performed efficacious hand hygiene, a luminescent composition, applied to a target surface, may emit luminescence within a first wavelength range over a threshold interval. Following the threshold interval of such embodiments, the selected luminescent marker of the selected luminescent composition may emit luminescence within a second wavelength range. For example, an activated selected luminescent marker may emit a purple luminescence during a threshold interval, and may experience a frequency shift after the threshold interval and emit a blue luminescence. Each of the first wavelength range and the second wavelength range may be between about 200 nm to about 400 nm, may be between about 400 nm to about 700 nm, or may be between about 700 nm to about 1 mm. The first wavelength range and second wavelength range may at least partially overlap or may be separate. In luminescent compositions exhibiting frequency shifting characteristics, it may be possible to control whether the composition performs up-conversion after the threshold period, or performs down-conversion after the threshold period. Thus, by judicious selection of a selected luminescent marker and a selected ionizing agent, it may be possible to realize an indicatory period using luminance intensity, luminance wavelength, or both.

The following example solutions may illustrate principles described thus far, relative to present embodiments:

Example Solution #1

| Constituent | Conc. (% by weight) (approx.) |
|---|---|
| ethanol | 70% |
| water | 29.98% |
| 4-methylumbelliferone (4-MU) | 0.02% |
| ammonium carbamate | 1.0% |

Example Solution #2

| Constituent | Conc. (% by weight) (approx.) |
|---|---|
| ethanol | 69.98% |
| dilute (3%) ammonia solution | 30% |
| 4-methylumbelliferone (4-MU) | 0.02% |

Example Solution #3

| Constituent | Conc. (% by weight) (approx.) |
|---|---|
| ethanol | 70% |
| water | 28.8% |
| 4-methylumbelliferone (4-MU) | 0.2% |
| ammonium carbamate | 1.0% |

Example Solution #4

| Constituent | Conc. (% by weight) (approx.) |
|---|---|
| ethanol or propanol | 69.8% |
| dilute (3%) ammonia solution | 30% |
| 4-methylumbelliferone (4-MU) | 0.2% |

Example Solution #5

| Constituent | Conc. (% by weight) (approx.) |
|---|---|
| ethanol | 70% |
| glycerol | 3% |
| 4-methylumbelliferone (4-MU) | 0.2% |
| water | 25.8% |
| ammonium carbamate | 1.0% |

Example Solution #6

| Constituent | Conc. (% by weight) (approx.) |
|---|---|
| ethanol | 66.8% |
| glycerol | 3% |
| 4-methylumbelliferone (4-MU) | 0.2% |
| dilute (3%) ammonia solution | 30% |

Example Solution #7

| Constituent | Conc. (% by weight) (approx.) |
|---|---|
| ethanol | 70% |
| water | 28% |
| 4-methylumbelliferone (4-MU) | 0.02% |
| Ethylhydroxyethylcellulose (EHEC) | 0.98% |
| ammonium carbamate | 1.0% |

The foregoing examples are provided for the purposes of illustration only, and in no way constitute an inclusive catalog of possible chemical systems, which may be prepared in view of the teachings herein.

Moreover, some embodiments herein also may provide persistent antimicrobial formulations, which may include persistence agents displaying residual antimicrobial activity. A persistence agent may be retained on the hands following washing as a residual skin coating, continuing to kill bacteria. A persistence agent may include, without limitation, chlorhexidine, triclosan, farnesol, lemon oil, benzalkonium chloride, or benzethonium chloride. A person of ordinary skill in the art would be knowledgeable of the characteristics and applications of persistence agents, including alternative persistence agents. In accordance with the teachings herein, luminescent compositions having persistence agents and displaying residual antimicrobial activity may, if appropriate, be modified to exhibit a persistent indicatory period, corresponding to an efficacious period of residual antimicrobial activity. Photometric quantification of luminescence on a target surface may indicate the amount of mechanical action applied to hand hygiene, the length of the hand hygiene event, the persistence of antimicrobial activity of the luminescent composition, or a combination thereof.

In addition to controlling the length of an indicatory period by judicious selection of constituent selected luminescent markers, and selected ionizing agents, luminescence can be attenuated by quenching. Quenching also may be accomplished by including a constituent of an encapsulated environment modifying additive (e.g., to raise or lower pH at a selected time after application). In addition, quenching may be effected by a reaction with oxygen (atmospheric or peroxides), by a reaction with halides (e.g., chlorides and bromides, and possibly the chlorides present on skin), by a reaction with proteins on skin (e.g., luminescence quenched when material is bound to skin proteins).

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as “comprising” (i.e., open language). The term “attached”, as used herein, is defined as connected, although not necessarily directly.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention, as defined by the appended claims.

1. A luminescent composition, comprising: a selected luminescent marker comprising a first phase of the luminescent composition; and a selected ionizing agent comprising a second phase of the luminescent composition, wherein the selected luminescent marker exhibits luminescence for a predetermined indicatory period responsive to intermixing of the first phase of the luminescent composition with the second phase of the luminescent composition, and wherein, due to a change in pH for a predetermined indicatory period, a luminance intensity remains at least at a threshold intensity.

2. The luminescent composition of claim 1, wherein the selected luminescent marker in an intermixture of the first phase of the luminescent composition with the second phase of the luminescent composition exhibits luminescence for a predetermined indicatory period responsive to an excitatory light applied to the luminescent composition.

3. The luminescent composition of claim 1, further comprising: a selected antimicrobial agent combined with the first phase of the luminescent composition, wherein intermixing of the first phase of the luminescent composition with the second phase of the luminescent composition comprises at least a portion of a hand hygiene protocol.

4. The luminescent composition of claim 2, further comprising: a selected antimicrobial agent combined with the first phase of the luminescent composition, wherein an intermixture of the first phase of the luminescent composition with the second phase of the luminescent composition is applied to at least a portion of a human hand, and wherein application of the luminescent composition comprises at least a portion of a hand hygiene protocol.

5. The luminescent composition of claim 1, wherein the selected luminescent marker includes a coumarinic compound and the selected ionizing agent includes a base having an ammonium compound therein.

6. The luminescent composition of claim 2, wherein the selected luminescent marker includes a coumarinic compound, the selected ionizing agent includes a base having an ammonium compound therein, and the excitatory light has a wavelength of between about 200 nm to about 400 nm.

7. The luminescent composition of claim 4, wherein the selected luminescent marker includes a coumarinic compound, the selected ionizing agent includes a base having an ammonium compound therein, the excitatory light has a wavelength of between about 200 nm to about 400 nm and the selected antimicrobial agent is ethanol, propanol, n-propanol, or an antimicrobially efficacious combination thereof, and wherein the selected antimicrobial agent has an alcohol concentration by weight of between about 60% and about 90%.

8. The luminescent compound of claim 2, wherein the excitatory light has a wavelength of between about 700 nm to about 1 mm.

9. The luminescent compound of claim 2, wherein the excitatory light has a wavelength of between about 400 nm to about 700 nm.

10. A luminescent composition, comprising: a selected luminescent marker comprising a first phase of the luminescent composition; and a selected ionizing agent comprising a second phase of the luminescent composition, wherein the selected luminescent marker exhibits luminescence for a predetermined indicatory period responsive to intermixing of the first phase of the luminescent composition with the second phase of the luminescent composition, and wherein, due to a change in pH for a predetermined indicatory period, a chromic shift remains at least at a threshold intensity.

11. A method of using a luminescent composition, comprising:
providing a selected luminescent marker;
providing a selected ionizing agent;
intermixing the selected luminescent marker with the selected ionizing agent;
causing a change in pH in the selected luminescent marker, responsive to the intermixing;
exhibiting luminescence for a predetermined indicatory period, responsive to the change in pH.

12. The method of claim 11, wherein exhibiting luminescence is by an excitatory light having a wavelength of between about 200 nm to about 400 nm, or between 400 nm to about 700 nm, or between about 700 nm to about 1 mm.

13. The method of claim 12, wherein exhibiting luminescence further comprises exhibiting a change in luminescence intensity for a predetermined indicatory period.

14. The method of claim 12, wherein exhibiting luminescence further comprises exhibiting a change in luminescence wavelength for a predetermined indicatory period.

15. The method of claim 11, wherein providing the selected ionizing agent further comprises providing a selected acidic ionizing agent and providing the selected luminescent marker further comprises providing a cationic fluorophor marker.

16. The method of claim 11, wherein providing the selected luminescent marker further comprises providing an amine-reactive fluorophor and providing the selected ionizing agent further comprises providing a zwitterionic amino acid found on the human skin, wherein an acid pH binds the fluorophor to a cationic site and a basic pH binds an anionic site to the fluorophor.

17. The method of claim 11, further comprising:
quenching the luminescence within a preselected time.
